(19) United States
(12) Patent Application Publication
(10) Pub. No.: US 2022/0102812 A1
(43) Pub. Date: Mar. 31, 2022

(54) BATTERY PACK

(71) Applicant: NARRABUNDAH TECHNOLOGY HOLDINGS PTY LTD, Narrabundah (AU)

(72) Inventor: Ken Yong LOH, Hughes (AU)

(21) Appl. No.: 17/426,447

(22) PCT Filed: Jan. 14, 2020
(86) PCT No.: PCT/AU2020/050018

§ 371 Date: Jul. 28, 2021

(30) Foreign Application Priority Data
Jan. 29, 2019 (AU) 2019900253

(51) Int. Cl. H01M 50/505; H01M 50/463; H01M 50/51; H01M 50/512

(52) U.S. Cl. CPC H01M 50/505; H01M 50/463; B60L 50/64; H01M 50/512; H01M 50/51

(57) ABSTRACT

A portable light weight battery pack (1) is formed of a pair of end plates (2), a plurality of cells (4) interposed between the end plates (2), and, a plurality of cell links (5). Each end plate (2) includes a first portion (6), and, a bus plate (11). The first portion (6) has a first surface (7) and a second surface (8), including, an arrangement of cutouts (9), and, an arrangement of fluid flow apertures (10). The bus plate (11) substantially overlays the first surface (7), and includes an arrangement of cell connection holes (12). An arrangement of fluid flow orifices (13) substantially align with said fluid flow apertures (10). The battery pack (1) may typically be used with electric vehicles and road-use assistance, for camping, mining and numerous industry applications.

### BACKGROUND OF THE INVENTION

The present invention relates to a battery pack, and in particular to a portable light weight battery pack.

In particular, the present invention relates to a configuration of specially designed end plates, which house the battery cells in a mechanically secure manner and which are optimised for thermal design and good electrical performance. The present invention also relates to an assembly of battery packs, a system and method for forming the end plates, the battery pack and/or the battery assembly.

The present invention is useful in a wide variety of applications where it is desirable to use a compact, lightweight and/or portable energy supply, such as, but not limited to, use with electric vehicles and road-use assistance therefor, camping, mining and numerous industry applications, etc.

### DESCRIPTION OF THE PRIOR ART

Any reference herein to known prior art does not, unless the contrary indication appears, constitute an admission that such prior art is commonly known by those skilled in the art to which the invention relates, at the priority date of this application.

Battery packs, particularly for portable applications, require a range of often conflicting performance requirements, including electrical conductivity, temperature regulation, mechanical strength, weight and energy-volume density.

Various attempts for temperature regulation solutions have been made, however most have excessive weight for portable applications. For example, some use liquids flowing through sealed fluid channels. Whilst these enable efficient and high throughput of thermal energy from cells by way of forced convection, they require additional reservoir(s), pumping components and structures for heat dissipation from the liquid (radiators) to function. The weight of the liquid itself, and these additional components, greatly increases overall system weight. The use of liquid coolant can have a significant benefit for use in electric vehicles or other devices which experience high transient loading, as the large heat capacity of the liquid can effectively absorb bursts of heat energy without significant heating. This benefit is not felt when the battery pack is under a continuous load, however, in this case, the heat capacity of the liquid becomes saturated and the thermal performance is limited by the component used to dissipate heat from the liquid (the radiator). Thus the cost-benefits of a liquid coolant based system are limited.

Direct dissipation of heat into the ambient environment has sometimes been performed using solid-state structures, or alternatively, “heat pipes” attached to the cells which transfer heat away to structures which are separate from the cells and optimised to dissipate heat to the environment. Similarly, some designs use structures directly incorporated into the structure of the cell or battery pack to improve heat dissipation.

Various attempts in seeking maximum energy-volume density and minimum weight have been made in which the batteries are simply packed cells together without any cooling structures or space between the battery cells. This maximises energy-volume density but severely limits the thermal performance of the battery pack.

Various other attempts have been made wherein a framing structure consisting of two plate-like structures to which the cells are mounted at opposite ends of the cells in order to mechanically connect the cells and maintain a relative position between the cells, such is described in U.S. Pat. Nos. 5,578,392 and 7,189,473. Both these systems include additional holes in these framing structures to enable flow of fluid through the space between cells and through the battery pack for thermal regulation, however, their design is not optimised.

### SUMMARY OF THE INVENTION

The present invention seeks to overcome at least some of the disadvantages of the prior art.

The present invention also seeks to provide a battery pack, and particularly end plates therefor, which have differences and advantages over prior art battery pack and end plate designs.

The present invention also seeks to provide a battery pack, and particularly end plates therefore, which are light weight and therefore appropriate to portable applications, such as, but not limited to use with electric vehicles.

The present invention also seeks to provide a battery pack, and particularly end plates therefor, which have efficient thermal and other operational characteristics.

The present invention seeks to provide a battery pack including two or more electrical energy cells which are electrically and mechanically connected by means of specially designed end-plate-frames which attach to the ends of the cells. The end-plate-frames are designed such that an optimised balance between battery pack requirements of electrical conductivity, temperature regulation and weight is achieved. Simultaneously, requirements of mechanical strength and cell gas ventilation are met. The temperature regulation with minimal weight cost is achieved through means of interconnected fluid channels formed by the space between bodies of the energy cells and a plurality of holes in the end-frame-plates which together enable efficient transfer of heat between the battery pack and a fluid used for thermal regulation, and efficient flow of the fluid through the battery pack. Design of the electrically connecting component incorporated into the end-frame-plates maximises conductivity around holes of the fluid channel system and the holes required to allow venting of gases from the cells. The mechanical component of design enables the above while minimising weight.

In one broad form, the present invention provides an end plate for a battery pack, the end plate including:
a first portion, of substantially plate-like configuration having first and second surfaces, including:
   an arrangement of cell receiving cutouts formed therein in spaced apart relationship; and,
   an arrangement of fluid flow apertures provided intermediate said cell receiving cutouts; and,
a bus plate, of substantially laminar configuration and formed of conductive material, substantially overlaying said first surface of said first portion, including:
   an arrangement of cell connection holes formed therein in spaced apart relationship and substantially in alignment with said cell receiving cutouts of said first portion; and,
   an arrangement of fluid flow orifices formed therein and which substantially align with said fluid flow apertures of said first portion.

Preferably, each cell receiving cutout is shaped such that, in use, the ingress of a cell received via the second surface of said first portion is restricted.

Also preferably, at least a portion of a side wall of the cell receiving cutout includes any one or combination of:
a shoulder;
a lip;
a step; or,
an incline.

Preferably, the cell receiving cutouts are of substantially compatible shape to the shape of a cell adapted to be inserted therein, such as, but not limited to circular, square, rectangular or any other shape, in cross-section.

Also preferably, each fluid flow aperture and each fluid flow orifice is of substantially similar shape, together forming part of a fluid flow channel.

Also preferably, said first portion is at least partly formed of non-conductive material, which is preferably also able to resist temperatures over 60° C. and has low flammability, such as, but not limited to polycarbonate, polyaramid 6/6 glass-fibre reinforced, PTFE, PEEK, etc.

Also preferably, each fluid flow aperture and each fluid flow orifice is of substantially similar shape, together forming part of a fluid flow channel.

Also preferably, said bus plate is formed of any one or combination of a highly conductive material such as a metal such as, but not limited to copper, aluminium, nickel, etc., or a non-metallic conductor, such as, but not limited to graphene or a conductive polymer or a ceramic material.

In a further broad form, the present invention provides a battery pack, including a pair of spaced apart end plates, a plurality of cells interposed therebetween, and, a plurality of cell links;
each end plate including:
   a first portion, of substantially plate-like configuration having first and second surfaces, including:
      an arrangement of cell receiving cutouts formed therein in spaced apart relationship; and,
      an arrangement of fluid flow apertures provided intermediate said cell receiving cutouts;
   a bus plate, of substantially laminar configuration and formed of conductive material, substantially overlaying said first surface of said first portion, including:
   an arrangement of cell connection holes formed therein in spaced apart relationship and substantially in alignment with said cell receiving cutouts of said first portion; and,
   an arrangement of fluid flow orifices formed therein and which substantially align with said fluid flow apertures of said first portion;
each cell including a first end and a second end, the first end being operatively engaged in a cell receiving cutout of a first of said end plates, and, a second end being operatively engaged in a cell receiving cutout of a second of said end plates; and,
each cell link conductively connecting an electrode at a respective end portion of each said cell to the bus plate of its respective end plate.

Preferably, each cell receiving cutout is shaped such that, in use, the ingress of a cell received via the second surface of said first portion is restricted, such that the respective end portion of the battery is spaced apart from the first surface of said first portion.

Also preferably, at least a portion of a side wall of the cell receiving cutout includes any one or combination of:
a shoulder;
a lip;
a step; or,
an incline.

Preferably, said first portion includes a pair of insulated panels positioned back to back, wherein, in a first insulated panel, each cell receiving cutout is dimensioned so that an end portion of a cell can fit therein, and in a second insulated panel, each cell receiving cutout is dimensioned so that the respective end portion of the cell is impeded from fitting therein to abut a peripheral rim of the end of the cell.

Also preferably, the cell receiving cutouts are of substantial compatible shape to the shape of a cell adapted to be inserted therein, such as, but not limited to circular, square, rectangular or any other shape, in cross-section.

Preferably, each fluid flow orifice and each fluid flow aperture is of substantially similar shape and substantially align, together forming part of a fluid flow channel.

Preferably, said first portion is at least partly formed of non-conductive material, which is preferably also able to resist temperatures over 60° C. and has low flammability, such as, but not limited to polycarbonate, polyaramid 6/6 glass-fibre reinforced, PTFE, PEEK, etc.

Preferably, said bus plate is formed of any one or combination of a highly conductive material such as a metal such as, but not limited to copper, aluminium, nickel, etc., or a non-metallic conductor, such as, but not limited to graphene or a conductive polymer or a ceramic material.

In a further broad form, the present invention provides a battery assembly including a plurality of battery packs as hereinbefore described, connected in series and/or parallel.

Preferably, the battery assembly includes a link plate connecting the bus plates of adjacently positioned battery packs.

In a further broad form, the present invention provides a method for forming a battery pack including interposing a plurality of battery cells between a pair of end plates.

Preferably the method includes a method for forming a battery pack, further including attaching a cell link to connect each cell to a bus plate of each end plate.

In a further broad form, the present invention provides a method of forming a battery assembly including linking two or more battery packs using a link member.

### BRIEF DESCRIPTION OF THE DRAWINGS

The present invention will become more fully understood from the following detailed description of preferred but non-limiting embodiments thereof, described in connection with the accompanying drawings, wherein:

FIG. 1 illustrates a perspective view of a preferred embodiment of a battery pack of the present invention;

FIG. 2 illustrates an exploded view of the embodiment of FIG. 1;

FIG. 3 illustrates an exploded view of an alternatively preferred embodiment of the present invention;

FIG. 4 illustrates a perspective view of a preferred embodiment of the end plate component the battery pack;

FIG. 5 illustrates a cut-away view of the end plate component shown in FIG. 4;

FIG. 6 illustrates a cut-away view of the battery pack shown in FIG. 1;

FIG. 7 illustrates a plan view of a preferred arrangement of a cell cutout and fluid flow aperture/orifice pattern;

FIG. 8 illustrates how a hole arrangement of FIG. 7 may be defined;

FIG. 9 illustrates a comparative analysis of a hole arrangement;

FIG. 10 illustrates an alternative triangular hole arrangement;

FIG. 11 illustrates an alternative hexagonal hole arrangement;

FIG. 12 illustrates a perspective view of a preferred embodiment of a cell link component of the battery pack;

FIG. 13 illustrates a top view of the battery pack including the cell links;

FIG. 14 illustrates cross-sectional and perspective views, in FIGS. 14(a) and 14(b) respectively, showing the cell links connecting the bus plate to the cells;

FIG. 15 illustrates an alternative embodiment of a cell link arrangement;

FIG. 16 illustrates an assembly of multiple battery packs;

FIG. 17 illustrates a pair of battery packs connected by a conductive linking plate;

FIG. 18 illustrates an eye/ring crimp arrangement used to connect to a bus plate;

FIG. 19 illustrates an end perspective view of the pair of battery packs of FIG. 17, showing the threaded inserts used for mounting the battery packs;

FIG. 20 illustrates a perspective view of a variation of the invention with a split bus plate;

FIG. 21 illustrates an exploded view of the embodiment of FIG. 20;

FIG. 22 illustrates an alternative rectangular cell arrangement; and,

FIG. 23 illustrates details of the hole arrangement of FIG. 22.

### DETAILED DESCRIPTION OF THE PREFERRED EMBODIMENT(S)

Throughout the drawings, like numerals will be used to identify like features, except where expressly otherwise indicated.

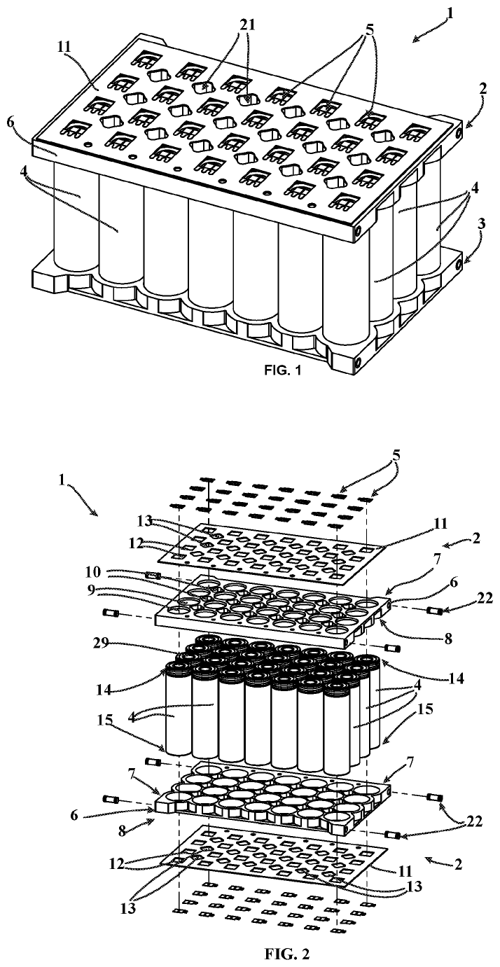

As shown in FIGS. 1 to 3, the battery pack 1 of the present invention includes a pair of spaced apart end plates 2 and 3, a plurality of electrical energy cells 4, herein referred to simply as cells 4, interposed therebetween, and, a plurality of cell links 5.

Each end plate 2 is preferably embodied to include a first portion 6 and a bus plate 11.

Each first portion 6 may be formed at least partly of non-conductive or insulative material, and, for ease of explanation, may be defined to include a first surface 7 and a second surface 8. Each first portion 6 of each end plate 2 preferably includes an arrangement of cell receiving cutouts 9, which are formed therein in spaced apart relationship, and, an arrangement of fluid flow apertures 10 provided intermediate the cell receiving cutouts 9.

The bus plate 11, which is preferably of substantially laminar configuration, and formed of conductive material, substantially overlays the first surface 7 of said first portion 6.

The bus plate 11, preferably includes an arrangement of cell connection holes 12 formed therein in spaced apart relationship, which are substantially in alignment with said cell receiving cutouts 9 of said first portion 6. The bus plate 11 also preferably includes an arrangement of fluid flow orifices 13 formed therein, which substantially align with said fluid flow apertures 10 of said insulated first portion 6, with each respective orifice 13 and aperture 10 together defining one end of a fluid flow channel 21.

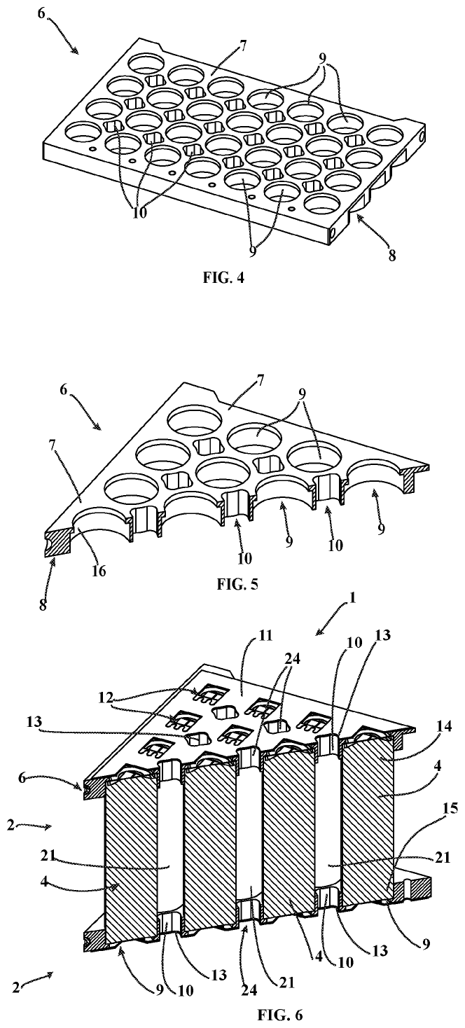

Each fluid flow channel 21 extends between the upper and lower end plates 2, and, therebetween in the spaces between the cells 4, as illustrated in FIG. 6. The fluid flow channels 21 permit fluid to flow past the cells 4, to assist in the thermal regulation of the cells 4.

The position of the end plates 2 to mechanically support the cells 4 in a manner whereby the cells 4 are spaced apart from each other, results in the optimised thermal regulation of the cells, and therefor optimised performance of the battery pack 1.

Each cell 4 may be defined, for ease of explanation, to include a first end 14 and a second end 15. The first end 14 of the cell is preferably operatively engaged in a cell receiving cutout 9 of a first of said end plates 6, and, a second end of the cell 15 is preferably operatively engaged in a cell receiving cutout 9 of a second of said end plates 6.

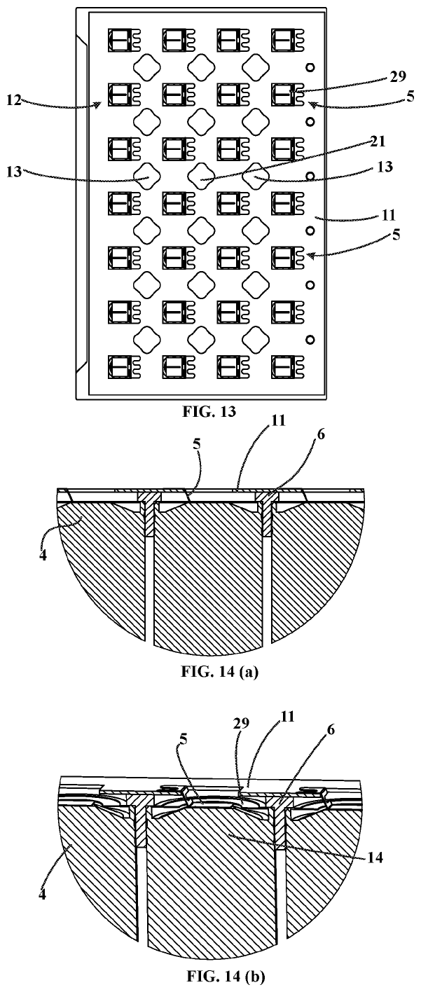

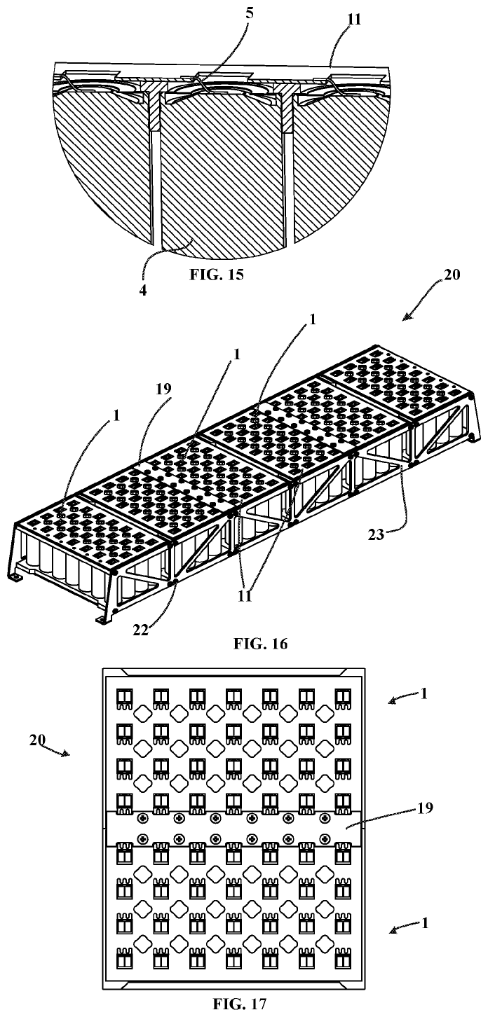

Each cell link 5, as detailed in FIG. 12, preferably conductively connects an electrode 29 at a respective end 14 or 15 of each said cell 4 to the bus plate 11 of its respective end plate 2. This is illustrated in FIGS. 13, 14(a) and 14 (b).

As shown in FIGS. 4 and 5, each cell receiving cutout 9 is preferably shaped such that, in use, the ingress of a cell 4 received via the second surface of said first portion 6 is restricted, such that the respective end portion 14 or 15 of the battery 4 is therefore spaced apart from the first surface 7 of said first portion 6.

At least a portion of a side wall of the cell receiving cutout 9 preferably includes any one or combination of a shoulder 16, a step, an incline, a lip or the like. This restricts the ingress of the cell 4 and keeps the cell 4 spaced apart from the first surface 7 of the first portion 6, and therefore, separated from the bus plate 11. This press-fit or interference fit of the cells 4 into the cell receiving cutouts 9 may, in one embodiment of the invention, facilitate a quick and easy assembly of the battery pack 1. In other embodiments, it may be desirable to bond the cells 4 into the end plates 2 using an adhesive.

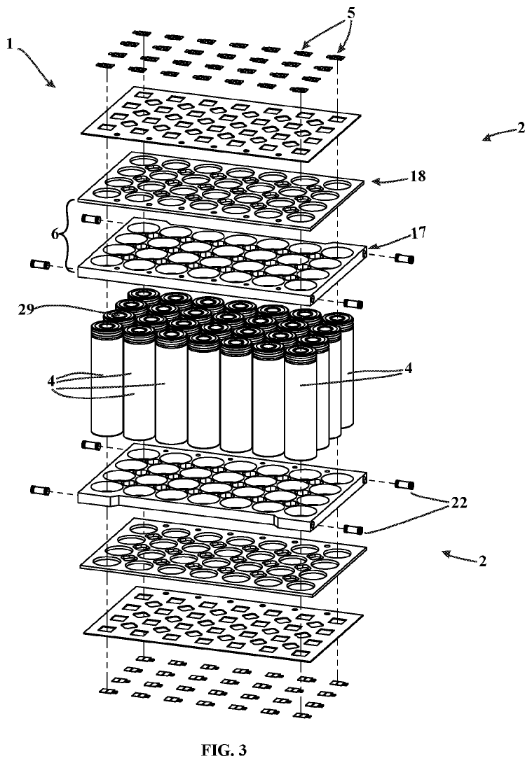

As shown in the embodiment of FIG. 3, the first portion 6 may, in one form, be embodied as a pair of panels 17 and 18 which are formed separately, and then positioned back to back. That is, in a first panel 17, each cell receiving cutout 9 is dimensioned so that an end portion 14 of a cell 4 can fit therein, and, in a second panel 18, each cell receiving cutout 9 is dimensioned so that the respective end portion 14 of the cell 4 is impeded from fitting therein, but rather, abuts a peripheral rim of the end of the cell 4.

The first portion 6 may be formed entirely or only partly of non-conductive or insulative material. An important aspect of the first portion 6 is that it is not electrically conductive adjacent the bus plates 11, that is, that it includes a non-conductive barrier to prevent the component of a whole from conducting electricity. The remainder of the first portion 6 may therefore be formed of a material which could electrically conduct, or, be formed of a semi-conductive material.

The cell receiving cutouts 9 may be of any desired shape, to complement the shape and appropriately fit a cell 4, by, for example, by pressing each cell 4 into the cutout 9 so as it is then retained therein. The embodiment of FIG. 6 shows cells receiving cutouts 9 which are of circular cross-sectioned shape, to be compatible with circular shaped cells 4, however, the cells/cutouts may be square, rectangular or of any other compatible cross-sectioned shape.

Also, in a preferred form, each fluid flow aperture 10 and each fluid flow orifice 13 is of substantially similar shape, and, these substantially align with each other, to define a portion of the fluid flow channel 21 through the respective end plate 2.

The battery pack 1 is preferably embodied wherein the first portion 6 is at least partly formed of non-conductive material, preferably able to resist temperatures over 60° C. and of low flammability. Examples may include, but are not limited to polycarbonate, polyaramid 6/6 glass-fibre reinforced, PTFE, PEEK, etc.

The first portion 6 can be formed entirely of non-conductive material or can alternatively be formed using a conductive material with non-conductive barrier(s) used to prevent the component as a whole from conducting electricity, such as, but not limited to, sheet-metal laminated with a thin, non-conductive plastic sheet.

The bus plate 11 is preferably formed of any one or combination of a highly conductive material such as a metal such as, but not limited to copper, aluminium, nickel, etc., or a non-metallic conductor, such as, but not limited to graphene or a conductive polymer or a ceramic material.

Whilst any fluid, including a liquid or gas, may be used for the thermal regulation, the present invention preferably uses air as the ‘fluid’. This minimises weight of the battery pack.

In use, a plurality of battery packs 1 may be connected in series and/or parallel, to form the battery assembly 20 as shown in FIGS. 16 and 17. This may be embodied using a link plate 19 to connect the bus plates 11 of adjacently positioned battery packs 1.

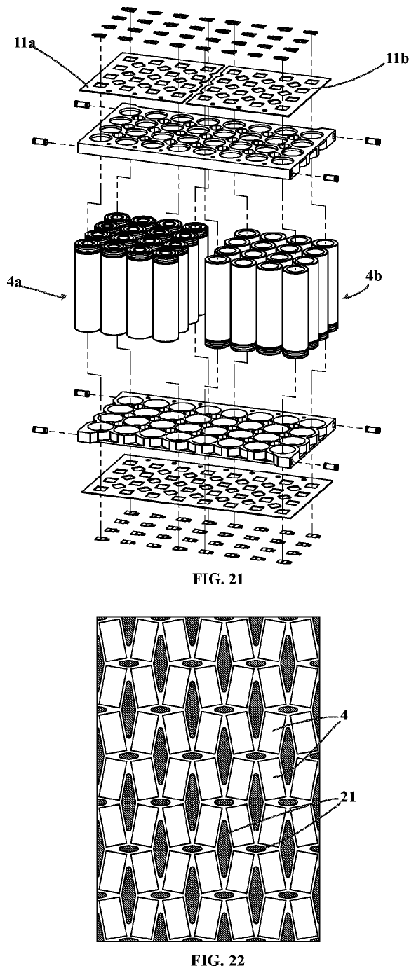

FIGS. 20 and 21 illustrate perspective and exploded views, respectively, of another preferred embodiment of a battery pack 1 the present invention, with the bus plate 11 on one side of the battery pack 1 being split into two electrically isolated sections 11a and 11b, and, having the cells 4 arranged into two subsets 4a and 4b such that the voltages of the two subsets sum. In this embodiment, the cells 4a and 4b are effectively connected in series, such that a higher output voltage is achieved.

Whilst the present invention has been hereinbefore described as relating to a battery pack, it will be appreciated that the invention also relates to the individual components of the battery pack, including, in particular, the end plates 2 of the battery pack 1. The individual components of the invention will be described in more detail as follows:

### Electrical Energy Cells

The battery pack 1 consists of a plurality of electrical energy cells 4 electrically and mechanically connected. These electrical energy cells 4 are self-contained units capable of outputting electrical energy that may be, but are not limited, to electrochemical cells such as lithium-ion cells, lithium-metal cells, nickel-metal cells or lead-acid cells, flow battery cells and fuel cells such as proton exchange membrane fuel cells. In the case of flow battery cells and fuel cells the gas venting function is instead utilised for input of reactant chemicals and output of reaction products.

A preferred embodiment is shown using cylindrical cells 4 but the invention could also be implemented using rectangular or other prismatic cells. Due to the design making use of the mechanical structure of the cells, the cells 4 preferably have a rigid body capable of taking a mechanical load. Embodiments utilising ‘pouch’ cells would include reinforcing of the cells or an external frame to maintain battery pack structure.

### End-Plate-Frame

The energy cells 4 are held mechanically in place by end-plate-frame structures 2 also referred to simply as end plates 2. These consist of a plate like structure 2 with a plurality of holes into which cells 4 fit and are held. The cells 4 are sandwiched between said pair of end-plate-frames 2. A lip 16 around the edge of the holes 9 on the outside facing surface 7 of the end of the hole 9 limits the intrusion of cells 4 into the holes 9 and produces a gap between the end of the cell 4 and the bus plate 11 which is incorporated into the outside face of the end-plate-frame 2. The holes 9 locating and mechanically securing the cells 4 are located and positioned with gaps between them such that installed cells 4 are not in direct contact with one another and the interstitial spaces between cells 4 are interconnected.

The end-plate-frame 2 includes a first portion 6 which is preferably made at least partially of a non-conductive material which can also resist possible temperatures over 60° C. encountered in operation and has low flammability (e.g. Polycarbonate, Polyaramid 6/6 glass-fibre reinforced, PTFE, PEEK). The first portion 6 of the end-plate-frame 2 can be formed entirely of non-conductive material or can alternatively be formed using a conductive material with non-conductive barrier(s) used to prevent the component as a whole from conducting electricity, such as, but not limited to, formed sheet-metal laminated with a thin, non-conductive plastic sheet.

Also composing the end-plate-frame 2 is a bus plate 11, which is preferably of substantially laminar configuration, and formed of conductive material, substantially overlays the first surface 7 of said first portion 6.

The cells 4 may be mechanically bonded to the end-frame-plates 2 by means of an adhesive, or be press fit or interference fit into the end-frame-plate 2 and external framing structures used to hold end-frame-plates 2, the cells 4 being sandwiched therebetween.

The end-frame-plates 2 may be coloured to aid identification of the end-frame-plate 2 as being attached to the positive or negative electrodes of the cells 4.

### Interstitial Thermal Regulation Fluid Flow Channels and Holes

In the interstitial spaces between cell cutouts 9 on the end plates 2, are the fluid flow holes 24 which form ends of the fluid flow channels 21. Each channel 21 is formed by the aligned fluid flow apertures 10 and fluid flow orifices 13 of the end plates which together form fluid flow holes 24, and, the space between the end plates adjacent the cells 4. The fluid flow channels 21 enable the flow of fluid through the interstitial spaces between the cells 4. The fluid flow channels 21 enable thermal regulation (primarily cooling but can also be used for heating). That is, the fluid flow channels 21 enable flow of thermal regulating fluid along the axial direction of the cells 4.

As illustrated in FIGS. 7, 8, 9, 10 and 11, the shape of the fluid flow holes 24 composed of fluid flow apertures 10 and fluid flow orifices 13, may be formed by imaginary “offset shapes” 30 which trace the perimeter of the cell cutouts 9 with an offset such that the perimeters of adjacent imaginary offset shapes 30 overlap. The fluid flow hole is formed by the central interstitial region between overlapping imaginary offset shapes 30.

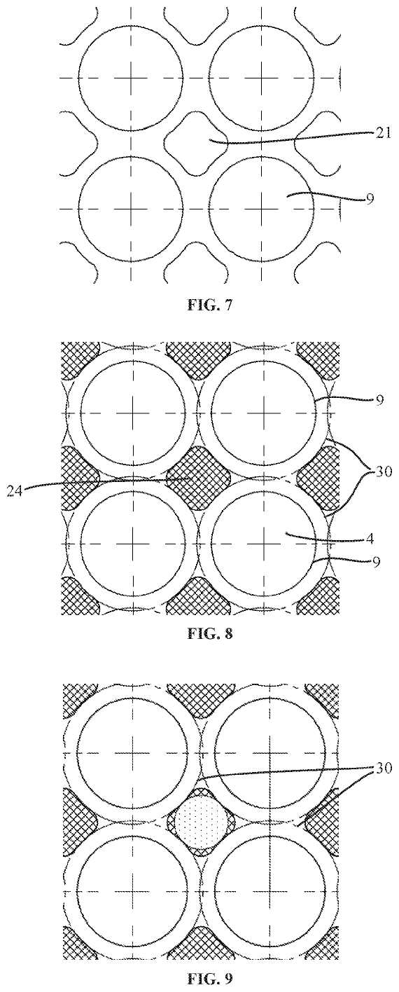

In the case of circular cells cutouts 9 arranged in a square-packing arrangement, such as shown in FIGS. 7 and 8, this results in a shape that is approximately diamond shaped but with concave curving sides. The corners of the fluid flow holes 24 may be “filleted” to prevent stress concentration that could result in cracking of the end plate 2. This method of defining the geometry of the fluid flow holes 24 creates the maximum possible surface area hole while maintaining constant thickness of material around the cell cutouts 9, thereby maintaining mechanical integrity while reducing weight and maximising efficiency of fluid flow.

### Bus Plate

Incorporated into the end plate 2 is a bus plate 11. This bus plate 11 is formed of conductive material used to electrically connect the cells 4 by collecting current from multiple cells. The bus plate 11 is formed of any one or combination of a highly conductive material such as a metal such as, but not limited to copper, aluminium, nickel, etc., or a non-metallic conductor, such as, but not limited to graphene or a conductive polymer or a ceramic material.

Orfices 13 are provided in the bus plate 11 matching the fluid flow apertures 10 of the underlying end-frame-plate insulated component, together forming fluid flow holes 24. The holes or cutouts 12 located above the cell mounting holes 9 are typically differently sized to the underlying cell cutouts 9. The bus plate 11 is not directly connected to the cells 4. Instead, the cutouts 12 located above cell cutouts 9 provide a location for the cell links 5 connecting the bus plate 11 to the electrodes of the cells 4 which are on a plane offset to the surface of the bus plate 11. This offset and link holes 12 are important to maintaining a path for gases venting from the cells 4. If the bus plate 11 were connected directly to the cells 4 without a path for gases to vent then this could present a safety hazard due to entrapment of gas. This path can also be used for delivery and removal of chemicals consumed and produced by some types of energy cells such a fuel cells and flow battery cells. The size of cell link holes 12 is preferably minimised in order to maximise surface area of the bus plate 11 and thus maximise conductivity, while still allowing sufficient access to install cell links 5 and allow venting of cells 4.

The bus plate 11 can be incorporated into the end-plate-frame 2 by means of over-moulding or adhesive. There is no end-frame-plate material supporting the bus plate 11 directly above the cell cutout 9 in order to allow a path for venting of gas from the cell 4. In other areas beneath the bus plate 11, the presence of the end-plate-frame beneath the bus plate 11 helps to maintain the structural integrity of the bus plate 11.

Thermal performance of the bus plate 11 can be further improved by ‘fins’ protruding out from the bus plate 11 surface or intruding into the interstitial fluid flow apertures 10 to enable better thermal coupling of the bus plate 11 to the thermal regulating fluid flow. This however has the drawback of added complexity, weight and space occupied.

### Cell Links

The design preferably implements fusible cell links 5. A fusible link may include a pad 25 for connection to the bus plate 11, a pad 26 for connection to the cell electrode 29, and, a fusible conductor 27 between the two. The bus plate connecting pad 25 can be bonded to the bus plate 11 by means of soldering or, directly welding using a resistance, laser or ultrasonic welding process. The bus plate connecting pad 25 features but does not require a meandered edge to reduce stress concentration and increase the perimeter of the bus plate connecting pad 25 thereby increasing bonding efficiency particularly for soldering or resistance welding compared to using a straight edge along the bus plate connecting pad 25. The bus plate connection pad 25 and cell electrode connection pad 26 planes are parallel while the fusible conductor 27 between them is angled to produce offset between the planes of the bus plate connection pad 25 and cell electrode connection pad 26 in order to make the connections to the offset bus plate 11 and cell 4 electrodes as previously described for venting of gases or delivery and removal of chemicals to and from the electrical energy cell 4. The cell connection pad 26 shows a split oriented parallel to the direction of expected current flow under typical use. This split may be optionally included to aid resistance welding of the cell connection pad 26 to the cell 4 electrode but would not be required for alternative methods of bonding such as laser welding, ultrasonic welding or pulse arc welding.

The fusible conductor section 27 of the cell link 5 consists of a section of conductor with a narrowed cross-sectional area. This narrowed cross-sectional area produces a region of concentrated current which in a short circuit failure event will be sufficient to cause destruction of the fusible conductor section due to ohmic heating, thereby severing electrical connection to the linked cell and limiting damage to the linked cell and battery pack as is the typical action of a fuse.

Fusible cell links may also be produced by using a link with a cell connection pad including a hole for connection to a screw terminal cell. It is also possible to use fusible wires rather than sheet materials to implement the fusible cell link 5 as shown in FIG. 15.

Plain cell links that are not designed to ‘fuse’ can also be implemented in embodiments at the cost of reduced safety. Most commercial, modern li-ion cell designs incorporate internal devices such as positive temperature coefficient (PTC) component and a current interrupt device (CID) to ensure safety under short circuits or other failure events. When implementing the invention using such electrical energy cells, the use of fusible cell links is safety redundant.

Whilst bonded links 5 have been herein described for the use with a preferred embodiment of the invention, it will be appreciated that cell links could be used which are not rigidly bonded to the cells 4, but which could be designed to maintain highly conductive contact using a biased cell link arrangement which ensures contact is retained under vibration or shock conditions.

### Driving of Thermally Regulating Fluid Flow

Flow of fluid, such as air or another fluid (including liquid or gas) through the battery pack 1 in order to regulate temperature can be achieved by both natural and forced convection. Design of the battery pack 1 for high flow efficiency and large exposed area of the cells 4 within the fluid flow channels 21 means that thermally regulating fluid flow can be self-driven through the battery pack 1 by means of natural convection. Natural convection occurs most efficiently when the battery pack 1 is oriented with fluid flow holes 24 on opposite sides aligned vertically with respect to gravity thereby encouraging vertical natural convection driven fluid flow through the battery pack. Natural convection will still occur with the battery pack 1 in different orientations but would be less efficient.

In the event natural convection is insufficient to drive adequate thermally regulating fluid flow through the battery pack 1, forced convection can be used. The forced convection could be achieved simply by means of locating a fan in close proximity, to induce or motivate a flow of fluid through the battery. Forced convection could also be achieved by means of a manifold system which directs a forced fluid flow through the battery pack.

### Electrically Connecting Battery Packs

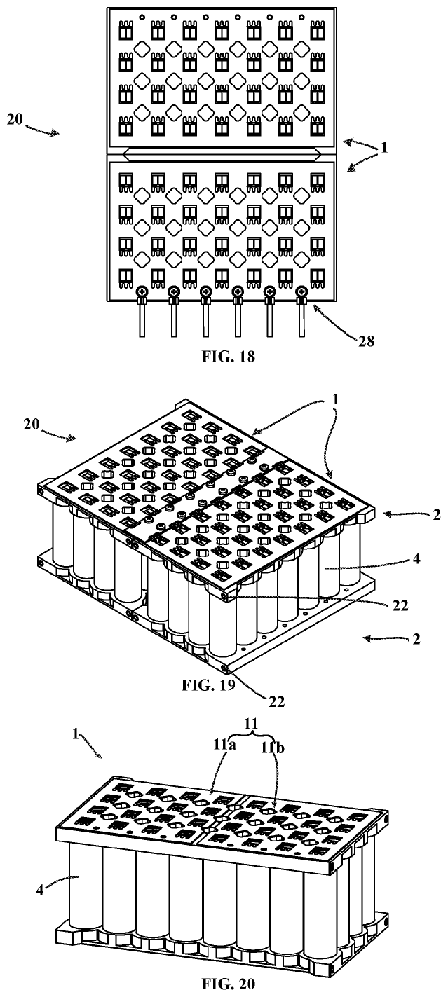

Electrical connection to the battery pack 1 in order to draw current and power is done by an area on the bus plate 11 with screw holes allowing attachment of conventional bus plate or busbar connectors 28, as shown in FIGS. 17 and 18.

The bus plate connection area also serves as a means of linking multiple battery packs 1. The positive bus plate of one battery pack 1 can be connected to the negative bus plate of another battery pack 1 to sum the voltage of the two packs. Alternatively, packs 1 can be connected with positive to positive to sum the current capacity of the two packs 1.

The end plates 2 on opposite sides of the pack are oriented such that the bus plate connection areas for the opposite plates are located on opposite corners of the battery pack 1. The location of the bus plate connection areas in opposite corners for the top and bottom electrodes allows efficient connection of two or more battery packs in series.

### Mechanically Connecting Battery Packs

Mechanical connection of the battery pack 1 to the enclosure/system in which the battery pack(s) find use is achieved by screwing into threaded inserts 22 embedded into the end-plate frames, as shown in FIG. 19. Threaded inserts 22 are inserted into holes in the end frame plate 2 by means of over moulding or adhesive. Frame structures 23 for mounting the battery packs 1 can then be screwed to the end-frame-plates through the threaded inserts 22, as shown in FIG. 16.

### Alternative Embodiments

Shown in FIG. 3 is an alternative embodiment with simpler geometry and first portion 6 of end plate 2 split into a cell spacer panel 17 and a bus plate standoff panel 18 to allow fabrication from 2D-cut (e.g. routed, waterjet cut, laser cut) sheets.

### Alternative Cell Packing Arrangements

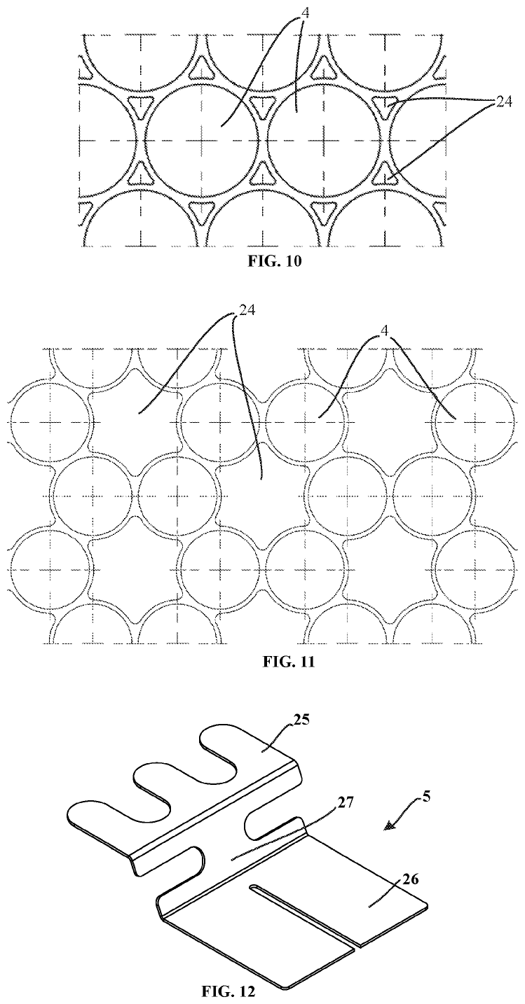

Alternative configurations of cell packing arrangements are shown in FIGS. 10, 11, 22 and 23.

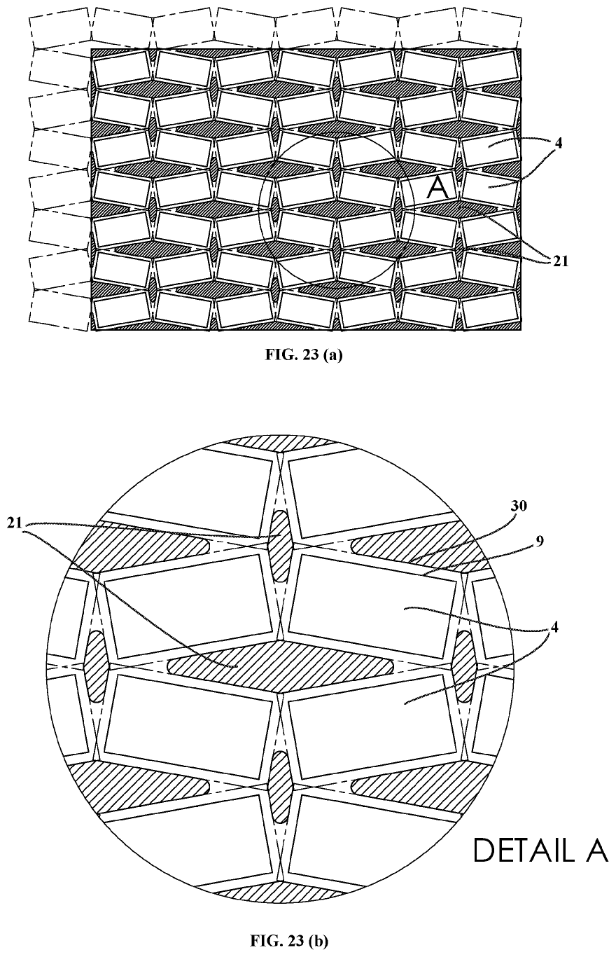

FIG. 10 shows a triangular arrangement and FIG. 11 shows a hexagonal arrangement, using circular cells 4, whilst FIGS. 22 and 23 show an alternative arrangement using rectangular-shaped cells 4.

A triangular cell packing embodiment as shown in FIG. 10 improves cell density of battery pack but reduces thermal regulating fluid flow efficiency. Interstitial fluid flow channels 21 and holes 24 must be much smaller. Thermal performance is sacrificed for battery pack density improvement.

Regular cell packing in also possible using a hexagonal arrangement, as shown in FIG. 11. This implementation increases the available cross-sectional area for fluid flow and significantly decreases the cell density. This improves thermal performance but greatly sacrifices battery pack density.

FIGS. 22 and 23 illustrate different cell packaging arrangements utilising rectangular shaped cells 4, FIG. 22 showing an end plate geometry using rectangular cell cutouts 4, and FIG. 23 detailing fluid flow holes showing offset shapes 30 used to define fluid flow channels for the rectangular cell arrangement.

As will be appreciated by persons skilled in the art, cells 4 of any desired shape may be used in the present invention, and hence fluid flow channels 21 of varying shape may be consequently chosen to optimise the thermal performance characteristics of the battery pack 1.

### Series Cells for Higher Voltage

Embodiments described hereinbefore are all single “series” configurations. That is, the battery packs consist of all cells 4 arranged with positive electrodes of the cells connected to only other positive electrodes and negative electrodes connected to only other negative electrodes. This produces a battery pack 1 of high current capacity but only the voltage output equal to that of an individual cell 4. In order to configure battery packs of higher voltages cells are connected “in series” i.e. a subset of cells 4 has their positive electrodes are connected to the negative electrodes of another subset of cells 4. This can be achieved by connecting separate battery packs 1 as described hereinbefore under the heading “Electrically Connecting Battery Packs” but, can also be done within a battery pack 1 to raise the output of the battery pack 1 at the expense of current capacity.

To produce a higher voltage battery pack 1 the bus plate 11 may be split into two or more electrically isolated sections on one or both sides of the battery pack. Each ‘series’ subset of cells has all electrically connected positive electrodes and separately all electrically connected negative electrodes on the opposite side of the battery pack. The positive electrodes of the ‘series’ subset are also connected to the negative electrodes of another adjacent series subset. Similarly, the negative electrodes of the series subset are connected to the positive electrodes of another adjacent series subset. Alternating series subsets have flipped orientation in the battery pack to allow connection of positive to negative electrodes or negative to positive electrodes on a single side of the battery pack. In this manner, series subsets are sequentially connected ‘in series’ such that the voltage of each series subset sums to produce a higher voltage. An embodiment of this higher voltage battery pack using two subsets of cells 4a and 4b connected in series is illustrated in FIG. 20 and FIG. 21.

### Reactant and Product Chemical Paths for Some Types of Electrical Energy Cells

As mentioned hereinbefore, the design features open paths to the cell electrodes primarily for the purpose of venting of gases from the cell 4 which can be produced in some circumstances when using sealed electrochemical cells. This path formed by the bus plate link hole 12, end-frame-plate cell hole lip 16 and cell link 5 can also be used as a path for delivery and removal of reactant chemicals consumed by and product/waste chemicals produced by some types of electrical energy cells. For example, hydrogen fuel cell or flow battery cell implementations can add pipes and widen the link hole 12 to allow delivery and removal of chemicals required for operation of the electrical energy cell.

The present invention relates generally to a battery pack 1 which includes two or more electrical energy cells 4 which are electrically and mechanically connected by means of specially designed end-plate-frames 2 which attach to the ends of the cells 4. The end-plate-frames 2 are designed such that an optimised balance between battery pack requirements of electrical conductivity, temperature regulation and weight is achieved. Simultaneously, requirements of mechanical strength and cell gas ventilation are met.

The temperature regulation with minimal weight cost is achieved through means of interconnected fluid channels formed by the space between bodies of the energy cells 4 and a plurality of holes in the end-frame-plates which together enable efficient transfer of heat between the battery pack 1 and a fluid used for thermal regulation, and efficient flow of the fluid through the battery pack. Design of the electrically connecting component incorporated into the end-frame-plates maximises conductivity around holes of the fluid channel system and the holes required to allow venting of gases from the cells. The mechanical component of design enables the above while minimising weight.

Throughout this specification, the term ‘plate-like’ has been used to describe the configuration of the end plates. The term ‘plate-like’ should be considered to be any three-dimensional shape having length, breadth and height. That is, it may be of any two-dimensional shape, such as, but not limited to, a square, a rectangle, a circle, etc. which also has a thickness component to it. The invention has been described in its preferred embodiment as being of square or rectangular shape, but this shape may be varied, as should be readily appreciated.

Throughout this specification, the term ‘laminar’ has also been used to describe the configuration of the bus plate. This is intended to mean any relatively thin sheet like structure which is provided on or proximal to the end plate, whether it be secured by means of adhesive or otherwise being physically attached, or, not actually attached but just overlaying one side of the insulated portion of the end plate.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

The present invention has been hereinbefore described with reference to one or more specifically disclosed embodiments. All variations and modifications of the invention which become apparent to a person skilled in the art should be considered to fall within the spirit and scope of the invention as broadly hereinbefore described and as hereinafter claimed.

1. An end plate for a battery pack, the end plate including:
a first portion, of substantially plate-like configuration having first and second surfaces, including:
an arrangement of cell receiving cutouts formed therein in spaced apart relationship; and,
an arrangement of fluid flow apertures provided intermediate said cell receiving cutouts; and,
a bus plate, of substantially laminar configuration and formed of conductive material, substantially overlaying said first surface of said first portion, including:
an arrangement of cell connection holes formed therein in spaced apart relationship and substantially in alignment with said cell receiving cutouts of said first portion; and,
an arrangement of fluid flow orifices formed therein and which substantially align with said fluid flow apertures of said first portion.

2. The end plate as claimed in claim 1, wherein each cell receiving cutout is shaped such that, in use, the ingress of a cell received via the second surface of said first portion is restricted.

3. The end plate as claimed in claim 2, wherein at least a portion of a surface wall of the cell receiving cutout includes any one or combination of:
a shoulder;
a lip;
a step; or,
an incline.

4. The end plate as claimed in any one of the preceding claims, wherein the cell receiving cutouts are of substantial compatible shape to the shape of a cell adapted to be inserted therein, such as, but not limited to circular, square, rectangular or any other shape, in cross-section.

5. The end plate as claimed in any one of the preceding claims, wherein each fluid flow aperture and each fluid flow orifice is of substantially similar shape, together forming part of a fluid flow channel.

6. The end plate as claimed in any one of the preceding claims, wherein said first portion is at least partly formed of non-conductive material, which is preferably also able to resist temperatures over 60° C. and has low flammability, such as, but not limited to polycarbonate, polyaramid 6/6 glass-fibre reinforced, PTFE, PEEK, etc.

7. The end plate as claimed in any one of the preceding claims, wherein said bus plate is formed of any one or combination of a highly conductive material such as a metal such as, but not limited to copper, aluminium, nickel, etc., or a non-metallic conductor, such as, but not limited to graphene or a conductive polymer or a ceramic material.

8. A battery pack, including a pair of spaced apart end plates, a plurality of cells interposed therebetween, and, a plurality of cell links;
each end plate including:
a first portion, of substantially plate-like configuration having first and second surfaces, including:
an arrangement of cell receiving cutouts formed therein in spaced apart relationship; and,
an arrangement of fluid flow apertures provided intermediate said cell receiving cutouts;
a bus plate, of substantially laminar configuration and formed of conductive material, substantially overlaying said first surface of said first portion, including:
an arrangement of cell connection holes formed therein in spaced apart relationship and substantially in alignment with said cell receiving cutouts of said first portion; and,
an arrangement of fluid flow orifices formed therein and which substantially align with said fluid flow apertures of said first portion;
each cell including a first end and a second end, the first end being operatively engaged in a cell receiving cutout of a first of said end plates, and, a second end being operatively engaged in a cell receiving cutout of a second of said end plates; and,
each cell link conductively connecting an electrode at a respective end portion of each said cell to the bus plate of its respective end plate.

9. The battery pack of claim 8, wherein each cell receiving cutout is shaped such that, in use, the ingress of a cell received via the second surface of said first portion is restricted, such that the respective end portion of the battery is spaced apart from the first surface of said first portion.

10. The battery pack of claim 8 or 9, wherein at least a portion of a side wall of the cell receiving cutout includes any one or combination of:
a shoulder;
a lip;
a step; or,
an incline.

11. The battery pack as claimed in any one of claims 8 to 10, wherein said first portion includes a pair of insulated panels positioned back to back, wherein, in a first insulated panel, each cell receiving cutout is dimensioned so that an end portion of a cell can fit therein, and in a second insulated panel, each cell receiving cutout is dimensioned so that the respective end portion of the cell is impeded from fitting therein to abut a peripheral rim of the end of the cell.

12. The battery pack of any one of claims 8 to 11, wherein the cell receiving cutouts are of substantial compatible shape to the shape of a cell adapted to be inserted therein, such as, but not limited to circular, square, rectangular or any other shape, in cross-section.

13. The battery pack of anyone of claims 8 to 12, wherein each fluid flow orifice and each fluid flow aperture is of substantially similar shape and substantially align, together forming part of a fluid flow channel.

14. The battery pack of any one of claims 8 to 13, wherein said first portion is at least partly formed of non-conductive material, which is preferably also able to resist temperatures over 60° C. and has low flammability, such as, but not limited to polycarbonate, polyaramid 6/6 glass-fibre reinforced, PTFE, PEEK, etc.

15. The battery pack of any one of claims 8 to 14, wherein said bus plate is formed of highly conductive material, including any one or combination of metal such as copper, aluminium, nickel, etc., or a non-metallic conductive material, such as, but not limited to graphene or a conductive polymer or ceramic material.

16. A battery assembly, including a plurality of battery packs as claimed in any one of claims 8 to 15, connected in series and/or parallel.

17. A battery assembly as claimed in claim 16, including a link plate connecting the bus plates of adjacently positioned battery packs.

18. A method for forming a battery pack including interposing a plurality of battery cells between a pair of end plates.

19. A method for forming a battery pack as claimed in claim 18, further including attaching a cell link to connect each cell to a bus plate of each end plate.

20. A method of forming a battery assembly including linking two or more battery packs using a link member.
